(19) United States
(12) Patent Application Publication
(10) Pub. No.: US 2015/0072573 A1
(43) Pub. Date: Mar. 12, 2015

(54) CRIMP TERMINAL, CABLE WITH TERMINAL, AND CABLE HARNESS STRUCTURE

(71) Applicants: FURUKAWA ELECTRIC CO.,LTD., Tokyo (JP); FURUKAWA AUTOMOTIVE SYSTEMS INC., Shiga (JP)

(72) Inventors: Yukihiro KAWAMURA, Shiga (JP); Takashi TONOIKE, Shiga (JP); Hiroshi ORITO, Tokyo (JP); Yasushi KIHARA, Tokyo (JP); Takuro YAMADA, Shiga (JP); Masakazu KOZAWA, Shiga (JP)

(21) Appl. No.: 14/481,877

(22) Filed: Sep. 9, 2014

Related U.S. Application Data
(63) Continuation of application No. PCT/JP2013/084628, filed on Dec. 25, 2013.

(30) Foreign Application Priority Data
Feb. 21, 2013 (JP) 2013-031939
Feb. 21, 2013 (JP) 2013-032398
Feb. 22, 2013 (JP) 2013-033845

(51) Int. Cl. H01R 13/11; H01R 4/18

(52) U.S. Cl. CPC H01R 13/11; H01R 4/183; H01R 4/188
USPC 439/867

(57) ABSTRACT

A crimp terminal (10) comprises a box part (20) and a cable connector (30). The box part (20) is connected to another terminal. The cable connector (30) is coupled with the box terminal (20) and connected with a covered cable (50). Also, the cable connector (30) includes a hollow formed by welding a metal plate, in which a pressing part for conduction (33b) and a compression part for waterproofing (33a) are formed. The pressing part for conduction (33b) presses a conduction part (51) of the covered cable (50) to ensure conduction with the covered cable. The compression for waterproofing (33a) presses and compresses a covered part (52) of the covered cable (50) inwardly to prevent water from entering inside.

### FIELD OF THE INVENTION

This invention relates to crimp terminals and the like that are electrically connected with covered cables by crimping.

### BACKGROUND OF THE INVENTION

Cable harnesses are wired throughout bodies of automobiles and used for supplying power to various electrical devices with which the automobiles are equipped, transmitting control signals between the electrical devices, and the like. The cable harness comprises a plurality of covered electric wires that are bundled together and terminals that are connected to these covered wires.

When crimp terminals are used, in order to prevent a conduction part from corrosion, it is necessary to prevent water from entering from a gap of the crimp terminal and a boundary between the covered cable and the crimp terminal. Particularly, when different metals are used for the crimp terminal and the connecting parts, entering of water must be prevented to prevent electrolytic corrosion. The prior Patent Document 1 and 2 disclose these types of technologies.

In Patent Document 1, when the conduction part of a covered cable is crimped to a crimp terminal, the conduction part is exposed at a plurality of locations at this point. Patent Document 1 discloses a technology of covering these exposed parts of the cable altogether by molded resin for waterproofing. Patent Document 2 discloses a technology of coating and covering only the exposed conduction parts with resin for waterproofing.

Also, if oxide film is formed on the conduction parts due to oxidization, it may not be possible to obtain a good conduction even if the cable is connected with the crimp terminal by crimping. In this regard, Patent Document 3 discloses a technology in which edges of grooves formed on the surface of the crimp terminal are pressed onto the conduction parts to remove the oxide film for better conduction.

### PRIOR ART DOCUMENTS

### Patent Documents

[Patent Document 1] JJP-A-2001-162647
[Patent Document 2] JP-A-2010-108828
[Patent Document 3] JP-A-2010-3584

### SUMMARY OF THE INVENTION

### Problems to be Solved by the Invention

However, the technologies disclosed in Patent Documents 1 and 2 are high cost since the costs for the resin itself, an apparatus for coating the resin, process of coating the resin, and the like are required. Also, in Patent Document 1 and 2, ensuring the conduction is difficult if the oxide film is formed on the conduction part of the electric wires.

On the other hand, the technology disclosed in Patent Document 3 aims for ensuring the conduction, and is irrelevant to waterproofing of the crimp terminal.

The present invention was achieved in view of such problems. It is an object of the present invention to provide a crimp terminal and the like which has the ability of good conduction and waterproofing at low cost.

### Means for Solving Problems

The problems to be solved are as described above, and means for solving the problems and its effects will now be described below.

According to a first aspect of the present invention, a crimp terminal comprising a terminal connector and a cable connector is provided. The terminal connector connects to another terminal (the counter terminal). The cable connector is coupled with the terminal connector and connects with a covered cable. Also, the cable connector includes a hollow formed by welding a plate-like material, in which a pressing part for conduction and a compression part for waterproofing are formed. The pressing part for conduction presses the conduction part of the covered cable to ensure conduction. The compression part for waterproofing presses and compresses the covered part of the cable to prevent water from entering into the cable connector.

Thereby, the electrical conduction can be ensured by the pressing part for conduction while the process of welding and the compression part for waterproofing completely prevent entering of water into the cable connector. Also, this way of preventing water from entering can reduce cost significantly compared to the structure utilizing molded resin and the like. Furthermore, since the covered part of the covered cable is compressed and fixed, the covered cable can be prevented from coming off even if a force pulling the cable is applied.

It is preferable that the pressing part for conduction comprises first grooves or protrusions that are formed on the inner surface of the hollow. It is also preferable that the compression part for waterproofing comprises second grooves or protrusions that are different from the first grooves or protrusions, and are formed on the inner or outer surface of the hollow. Thus, each of the pressing part for conduction and the compression part for waterproofing has a different type of unevenness.

Thereby, the pressing part for conduction and the conduction part can be electrically connected by the edges of the grooves or the protrusions. Also, the waterproofing can be achieved by pressing into the grooves or the protrusions into the covered part.

According to a second aspect of the present invention, a cable with a terminal is provided. The cable with a terminal comprises a crimp terminal having a terminal connector, which connects to another terminal, and a cable connector, which is coupled with the terminal connector and connects to the covered cable. The cable connector includes a hollow formed by welding a plate-like material, in which a pressing part for conduction and a compression part for waterproofing are formed. The pressing part for conduction presses the conduction part of the covered cable to ensure conduction. The compression part for waterproofing presses and compresses the covered part of the cable to prevent water from entering into the cable connector. The covered cable is connected to the cable connector.

Thereby, it is possible to provide the cable with a terminal, which has ensured electrical conduction with the covered cable and can completely prevent water from entering into the terminal, at low cost.

Preferably, in the cable with a terminal, the shape of the pressing part for conduction is different from the shape of the compression part for waterproofing. Particularly, it is preferred to use grooves for the pressing part for conduction and protrusions for the compression part for waterproofing, both of which are formed on the inner surface of the hollow.

By making the pressing part for conduction into shapes suitable for electrical conduction and the compression part for waterproofing into shapes suitable for waterproofing, the present invention can be more effective.

In the cable with a terminal, it is preferable that the compression part for waterproofing is formed over the whole circumference of the interior wall of the hollow.

Thereby, the higher waterproofing effect can be obtained since the whole circumference of covered part of the cable can be compressed.

In the cable with a terminal, it is preferable that the pressing part for conduction comprises a plurality of polygonal-shaped grooves or protrusions.

Thereby, the pressing part for conduction can be electrically connected with the conduction part securely with increased number of the edges of the grooves or the protrusions.

Preferably, in the cable with a terminal, a welding part formed parallel to the insertion direction of the covered cable exists on the surface of the cable connector and an end of the cable connector on the terminal connector side is sealed by welding.

Thereby, the cable connector is sealed everywhere except for the cable insertion part, ensuring waterproofing effect. It is also possible to reduce the costs significantly compared to the configuration utilizing molded resin and the like.

Preferably, the cable with a terminal is installed on automobiles.

That is, although it is common to use a plurality of bundled wires in automobiles, using molded resin and the like for all the terminals of the wires results in high cost. In this regard, the present invention can provide a configuration having a waterproofing property at low cost, which leads to significant reduction in cost.

Also, a plurality of cables with terminals, which include the crimp terminals and the covered cables connected to the cable connectors thereof, may be bundled together.

The conduction part of the covered cable may be made of aluminum or aluminum alloy.

### Effects of the Invention

According to the present invention, a crimp terminal and the like having the ability of good conduction and waterproofing can be provided at low cost.

### BRIEF DESCRIPTION OF THE DRAWINGS

FIG. 1 (a) is an exploded perspective view of a cable with a terminal according to an embodiment of the present invention.

FIG. 1 (b) is an exterior perspective view of the assembled cable with a terminal according to an embodiment of the present invention.

FIG. 2 (a) is a cross-sectional perspective view of a crimp terminal.

FIG. 2 (b) is a side cross-sectional view of the crimp terminal.

FIG. 3 (a) is a development view showing a first interior wall shape of the crimp terminal.

FIG. 3 (b) is a cross-sectional view of the first interior wall shape of the crimp terminal.

FIG. 4 (a) and FIG. 4 (b) are side cross-sectional views illustrating processes of connecting the crimp terminal and a covered cable.

FIG. 5 (a) is a development view showing a second interior wall shape of the crimp terminal.

FIG. 5 (b) is a cross-sectional view of the second interior wall shape of the crimp terminal.

FIG. 6 (a) is a development view showing a third interior wall shape of the crimp terminal.

FIG. 6 (b) is a cross-sectional view of the third interior wall shape of the crimp terminal.

FIG. 7 (a) is a side cross-sectional view of a fourth interior wall shape of the crimp terminal.

FIG. 7 (b) is a side cross-sectional view of a fifth interior wall shape of the crimp terminal.

FIG. 8 (a) and FIG. 8 (b) are side cross-sectional views illustrating processes of connecting the crimp terminal and a covered cable in a first variation.

FIG. 9 is an exploded perspective view showing the crimp terminal and the covered cable in a variation.

FIG. 10 is a partially developed view of a crimp terminal 10a.

FIG. 11 is a partial cross-sectional view of the crimp terminal 10a.

FIG. 12 (a) and FIG. 12 (b) are side cross-sectional views illustrating a process of connecting the crimp terminal and the covered cable in a variation.

FIG. 13 is a schematic view of a testing device.

FIG. 14 is a cross-sectional view of a cable with a terminal 1a.

FIG. 15 (a) shows an air pocket 27.

FIG. 15 (b) shows a projection 25.

FIG. 16 is a partially developed view of a crimp terminal 10b.

FIG. 17 (a) and FIG. 17(b) are side cross-sectional views illustrating a process of connecting the crimp terminal and a covered cable in a variation.

FIG. 18 is a partially developed view of a crimp terminal 10c.

FIG. 19 is an exploded perspective view of a cable with a terminal 1b.

FIG. 20 is a cross-sectional view of a crimp terminal 10d.

FIG. 21 is a cross-sectional view of the cable with a terminal 1b.

FIG. 22 is a cross-sectional view illustrating a method of crimping the cable with a terminal 1b with a crimping tool.

FIG. 23 shows the shapes of a first crimping mold 61 and a second crimping mold 62.

FIG. 24 is an enlarged view showing a flow of the conventional crimped part at a fitting section.

FIG. 25(a) is an enlarged view showing a flow of the crimped part at a fitting section before crimping in the present invention.

FIG. 25(b) is an enlarged view showing the flow of the crimped part at the fitting section after crimping in the present invention.

FIG. 26 is an exploded perspective view of a cable with a terminal in accordance with another embodiment of the present invention.

FIG. 27 is a cross-sectional view of a crimp terminal 10e.

FIG. 28(a) is an enlarged view showing a flow of the crimped part at a fitting section before crimping in the present invention.

FIG. 28(b) is an enlarged view showing the flow of the crimped part at the fitting section after crimping in the present invention.

FIGS. 29(a) to 29(d) show other embodiments of the present invention.

### DETAILED DESCRIPTION OF THE PREFERRED EMBODIMENTS

### First Embodiment

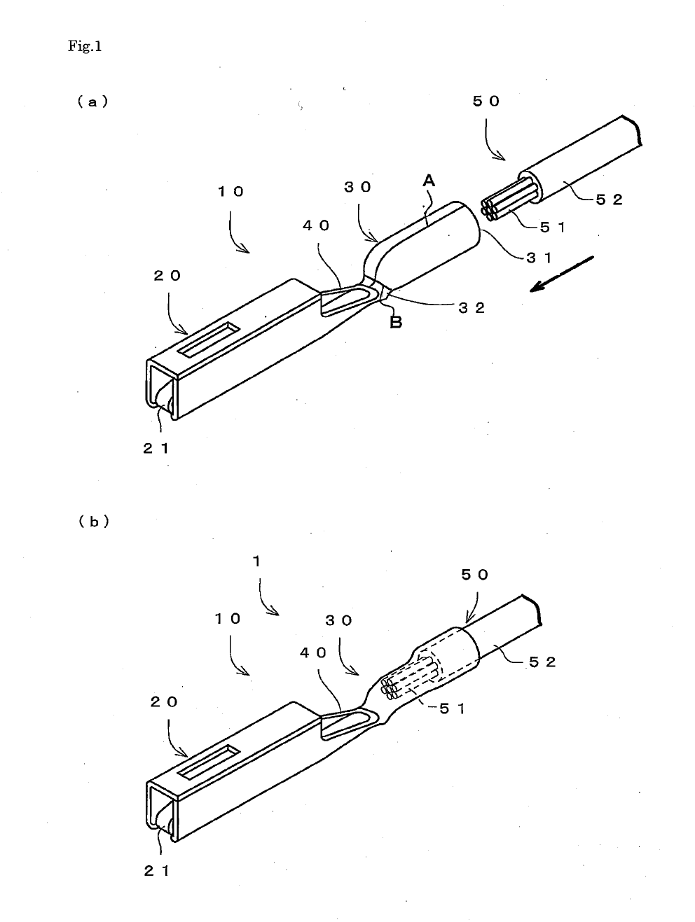

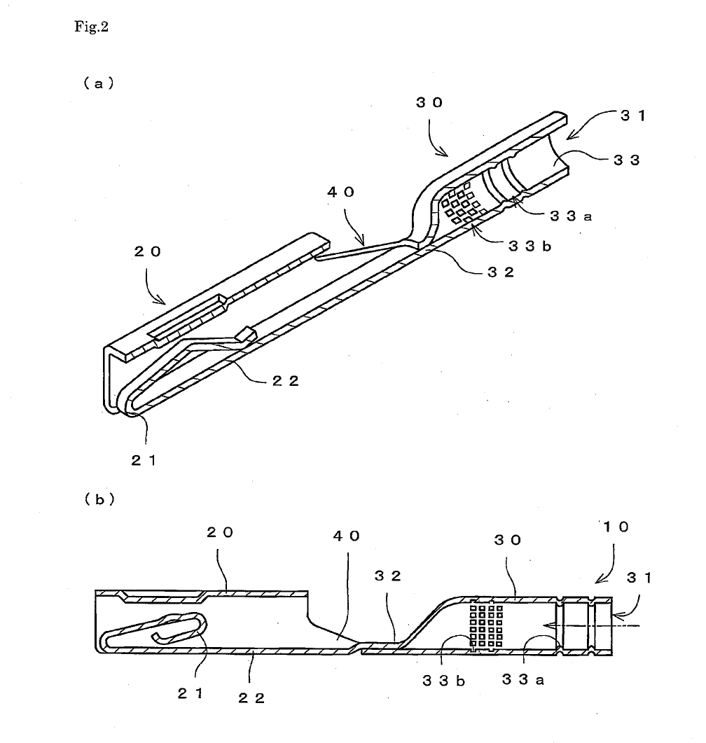

Embodiments of the present invention will now be described with reference to the attached drawings. FIG. 1 (a) is an exploded perspective view showing a structure of a cable with a terminal (cable harness). FIG. 1 (b) is an exterior perspective view of the cable with a terminal (cable harness) after crimping. FIG. 2 (a) and FIG. 2 (b) illustrate a crimp terminal, showing a cross-sectional perspective view and a side cross-sectional view respectively.

As shown in FIG. 1 (a) and (b), the cable with a terminal 1 comprises a crimp terminal 10 and a covered cable 50.

The covered cable 50 includes a conduction part 51 and a covered part 52. The conduction part 51 is made of a plurality of aluminum element wires bundled together. Other conducting materials other than aluminum, such as copper or copper-plated aluminum, may be used for the conduction part 51. The covered part 52 is made of an insulating material such as resin and the like, which surrounds the conduction part 51.

The crimp terminal 10 is a female terminal made of Sn-plated brass and the like. The crimp terminal 10 may be made of other conductive materials such as aluminum. The crimp terminal 10 can be electrically connected with the conduction part 51 of the covered cable 50 as well as a male terminal (another terminal or a counter terminal), which is omitted in the drawing. The male terminal is connected to other cables and electrical devices for supplying power or signals to the devices.

The crimp terminal 10 will be described in detail below. A metal plate is punched, bended, welded, and so forth to form the crimp terminal 10. As shown in FIG. 1 (a), the crimp terminal 10 has a box part (a terminal connector) 20, a cable connector 30, and a transition part 40.

The box part 20 is a rectangular parallelopiped with a hollow, shaped by bending the metal plate. As shown in FIG. 2, an elastic contactor 21 is formed by inwardly bending a bottom surface 22, which is one of the surfaces of the box part 20.

The elastic contractor 21 is formed on the tip of the box part 20. The elastic contractor 21 is configured so to be elastically deformed in a direction of leaving away from the bottom surface 22 or approaching the bottom surface 22. Inserting the male terminal, which is omitted in the drawing, pushes and transforms the elastic contractor to approach toward the bottom surface 22. The elastic contractor 21 then returns back to the original shape when the male terminal is completely inserted. Thereby, the box part 20 and the male terminal is electrically and mechanically connected.

The cable connector 30 is coupled with the box part 20 via the transition part 40. The cable connector 30 is cylindrical (with a hollow inside). One end of the cable connector 30, which is on the insertion direction of the covered cable 50, is open as an opening 31 and the other end (the end on the side of the box part 20) is sealed as a sealed part 32.

To form the cable connector 30, firstly, a metal plate is rolled and welded at the ends (the welded part A in FIG. 1 (a)) by fiber laser and the like to form a cylinder. Then, the metal plate on one end of the cylinder (on the side of the box part 20) is deformed, welded (the welded part B in FIG. 1 (a)), and sealed to form the sealed part 32. Here, the welded part A is formed parallel to the insertion direction of the covered cable 50 (the axial direction of the cylindrical part) and the welded part B is formed perpendicular to the insertion direction of the covered cable.

The method of forming the cable connector 30 is not limited to the method described above. For example, the metal plate may be rolled to form a cylinder first (no welding is performed at this point) then the one end can be compressed followed by welding. This can decrease the number of steps in the process and reduce the cost. Also, the welding can be performed in any ways. For example, edges of the metal plate may be simply in contact with each other, or may be overlapped for welding. Furthermore, the welded part may not be on the upper surface side (upper side of FIG. 1 (a)) but may be on the bottom surface side (lower side of FIG. 1 (a)).

The cable connector 30 is completed after the processes above. Welding at the welded part A, as described above, enables to prevent entering of water from the surface of the cable connector 30. Also, welding the welded part B to form the sealed part 32 enables to prevent entering of water from the gap between the cable connector 30 and the box part 20. A method to prevent entering of water from the opening 31 (water entering along the covered cable 50) will be described below.

Also, on the interior wall 33, which is a wall inside the cable connector 30, a pressing part for conduction 33b including first grooves (or concave part) or protrusions and a compression part for waterproofing 33a including second grooves (or concave part) or protrusions that are different from the pressing part for conduction 33b are formed. The compression part for waterproofing 33a fixes the covered cable 50 and prevents water from entering into the crimp terminal 10. The pressing part for conduction 33b allows good electrical conduction even if an oxide film covers the conduction part 51 of the covered cable 50.

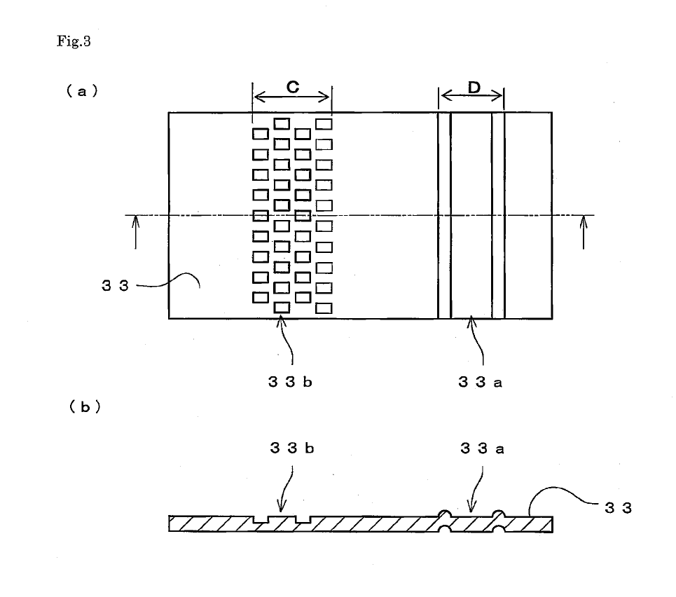

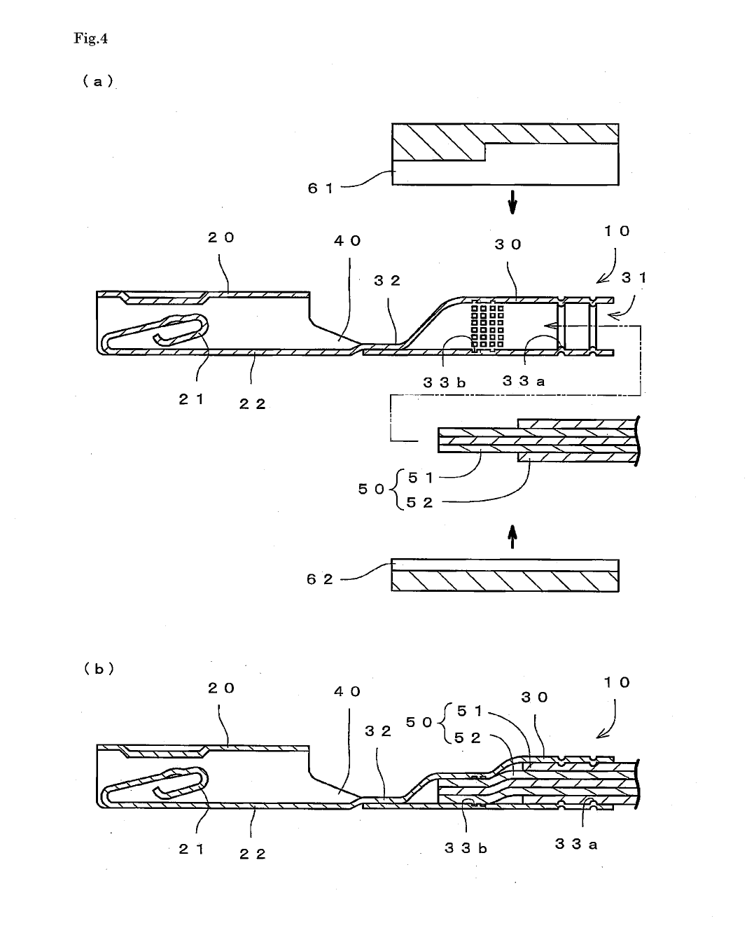

Hereinafter, the compression part for waterproofing 33a and the pressing part for conduction 33b will be described with reference to FIG. 2 to FIG. 4. FIG. 3 (a) and FIG. 3 (b) are a development view and a side cross-sectional view respectively showing the shapes of an interior wall 33 of the crimp terminal 10. FIG. 4 (a) and FIG. 4 (b) are side cross-sectional views illustrating processes of connecting the crimp terminal 10 and the covered cable 50. FIG. 3 (b) is a cross-sectional view of FIG. 3 (a) cut off at the chain line. In the side cross-sectional views, the shapes such as grooves that are behind the cross-section of the cable connector 30 on the paper may be omitted in the drawings for simplicity.

The compression part 33a for waterproofing includes, as shown in FIG. 2 and FIG. 3, protrusions (convex parts) formed over the whole circumference of the interior wall 33. “Formed over the whole circumference” means that not only the shapes are formed without intermission but the shapes may be formed, for example, avoiding the welded part. Also, although the compression part for waterproofing 33a has two protrusions in this embodiment, the shapes of the compression part for waterproofing 33a can be any shapes and may be changed appropriately (details will be described later).

It is preferable to have the protrusions of the compression part for waterproofing 33a to be disposed at two or more locations (two or more rows). Having two or more protrusions increases the tensile strength as the resin of the covered part fits into the gap(s) between the two or more protrusions.

The pressing part for conduction 33b includes, as shown in FIG. 2 and FIG. 3, a plurality of grooves (concave parts) formed on the interior wall 33. Although the pressing part for conduction 33b has a plurality of arranged rectangular shaped grooves, the shapes of the pressing part for conduction 33b can be any shapes and may be changed appropriately (details will be described later).

As shown in FIG. 3 (a), the area for the pressing part for conduction 33b (the longitudinal length C in the drawing) is larger than the area for the compression part for waterproofing 33a (the longitudinal length D in the drawing). That is, the longitudinal length between the both ends of grooves (concave parts) formed on the interior wall 33 of the pressing part for conduction 33b is longer than the longitudinal length between the both ends of the protrusions formed in the compression part for waterproofing 33a.

Thus, with a larger area of the pressing part for conduction 33b, it is possible to caulk the conduction part 51 over a larger area and increase the tensile strength and improves the electrical properties between the conduction part 51 and the connector. On the other hand, with a plurality of protrusions in a narrow area for the compression part for waterproofing 33a, the resin of the covered part 52 can be deformed drastically increasing the tensile strength and improving the waterproofing property between the covered part 52 and the connector.

As shown in FIG. 4 (a), to fix the covered cable 50 to the crimp terminal 10, the covered cable 50 is inserted into the cable connector 30, which is then interposed between a first crimp mold 61 and a second crimp mold 62 of a crimp tool to be caulked.

Thereby, as shown in FIG. 4 (b), the protrusions of the compression part for waterproofing 33a compress the covered part 52 and are pressed into the covered part 52 preventing water from entering into the crimp terminal 10 along the covered cable 50. In this embodiment, the protrusions are formed over the whole circumference of the interior wall 33 resulting in an effective waterproofing.

Also, in this embodiment, the conduction part 51 is made of aluminum or aluminum alloy and the crimp terminal is made of copper. When different metals are used for the cable connector 30 and the conduction part 51 as in this case, high waterproofing property is required to prevent electrolytic corrosion. In this respect, in the crimp terminal 10 in this embodiment, welding the surface prevents entering of water via the surface of the crimp terminal, and also the compression part for waterproofing 33a prevents entering of water via the cable, as described above. This waterproofing structure in this embodiment can reduce the costs significantly compared to the structure using molded resin and the like to fill in the gap between the cable connector 30 and the box part 20.

Furthermore, compressing the compression part for waterproofing 33a as above prevents the covered cable 50 from coming off from the crimp terminal 10 even if a force pulling the covered cable is applied.

Also, crimping as described above presses the conduction part 51 strongly by the pressing part for conduction 33b. Here, the edges of the grooves of pressing part for conduction 33b presses the conduction part 51 as lines, rather than surfaces. Therefore, even if an oxide film is formed on the surface of the conduction part 51, the pressing part for conduction 33b can reach into the aluminum part which is under the oxide film.

Also, in this embodiment, the cable with a terminal 1 can be manufactured efficiently since waterproofing via the cable, treatment for better conduction, and crimping can be done simultaneously.

### Other Embodiment 1

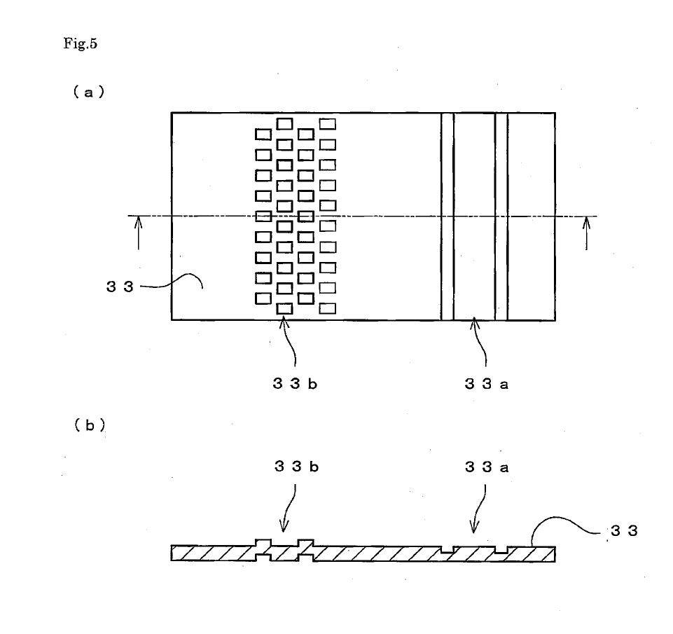

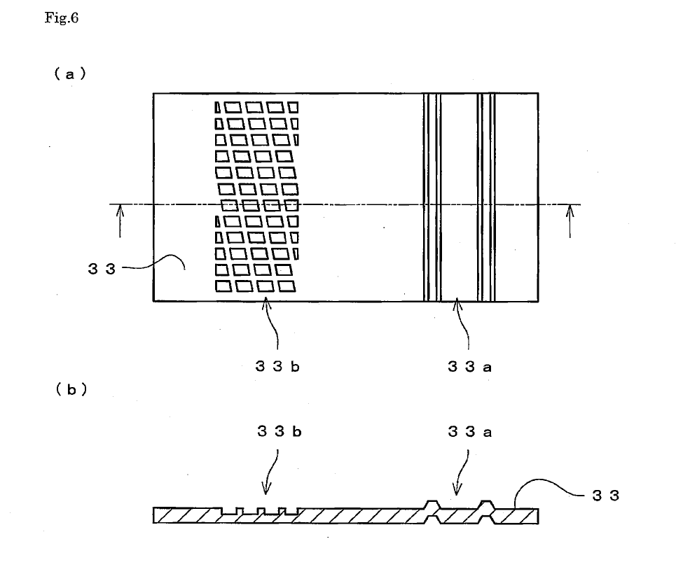

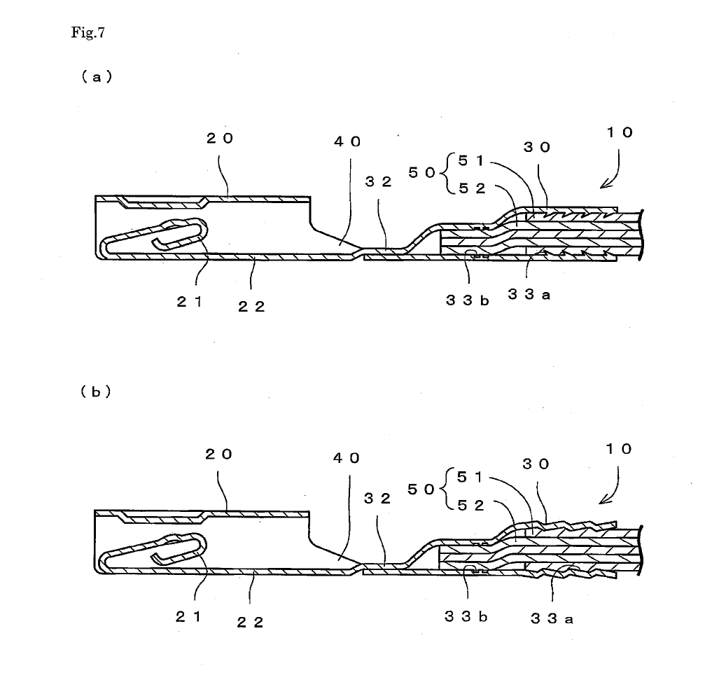

Next, other shapes for the compression part for waterproofing 33a and the pressing part for conduction 33b will be described. FIG. 5 and FIG. 6 are development views and side cross-sectional views showing other shapes on the interior wall 33 of the crimp terminal 10. FIG. 7 are cross-sectional views showing another shape on the interior wall 33 of the crimp terminal.

The other shapes of the compression part for waterproofing 33a will be described first. Alternative to the protrusions formed on the interior wall 33 of the compression part for waterproofing 33a in FIG. 3, grooves may be formed on the interior wall 33 as shown in FIG. 5. In this case, the covered part 52 is compressed by the edges of the grooves of the compression part for waterproofing 33a and fixed into the grooves.

The shapes of the grooves or the protrusions of the compression part for waterproofing 33a can be any shapes, and may be arc-shaped as in FIG. 3 (b), rectangular-shaped as in FIG. 5 (b), or trapezoidal protrusions as in FIG. 6 (b). Also, the number of grooves or protrusions of the compression part for waterproofing 33a can be any numbers and is not limited to two but can be one, three, or more than three.

Other than the shapes above, such a shape in which the protrusions have tips that gradually narrow as they approach the inner side of the cable connector 30 as shown in FIG. 7 (a) may be used for the compression part for waterproofing 33a. Using this shape can easily make the compression part for waterproofing 33a pressed into the covered part 52. Also, since the tips of this compression part for waterproofing 33a are pointing toward the box part 20, the covered cable 50 is prevented more securely from coming off even if a pulling force is applied to the covered cable 50.

The shapes of the compression part for waterproofing 33a are not limited to grooves or protrusions but may be in the form of inclinations as shown in FIG. 7 (b). With this shape, waterproofing can still be obtained because the covered part 52 can be compressed at the parts in which the diameter of the compression part 33a is small.

Next, the other shapes of the pressing part for conduction 33 b will be described. Alternative to the grooves formed on the interior wall 33 of the pressing part for conduction 33b in FIG. 3, protrusions may be formed on the interior wall 33 as shown in FIG. 5. In this case, the conduction part 51 is pressed with the corners and the like of the protrusions.

The shapes and arrangement of the grooves or the protrusions of the pressing part for conduction 33b can be any shapes and arrangements, and may be rectangular grooves s in FIG. 3 (a) or parallelogram-shaped grooves as shown in FIG. 6 (a). Furthermore, polygonal (triangular or pentagon-shaped) or circular grooves may be used as well. Although slit-like (rib-like) shapes can also be used for the grooves, forming a plurality of polygonal grooves may result in better conduction because the larger the number of the edges of the grooves, the easier to penetrate the oxide film on the conduction part 51.

As described above, larger number of the edges of the grooves is preferable for the pressing part for conduction 33b for better conduction whereas it is preferable that the compression part for waterproofing 33a is formed over the whole circumference (i.e. less edges of the grooves) for better waterproofing property. Therefore, the optimum shape for the compression part for waterproofing 33a is different from the optimum shape for the pressing part for conduction 33b.

The methods for forming the compression part for waterproofing 33a and the pressing part for conduction 33b will now described. The compression part for waterproofing 33a and the pressing part for conduction 33b may be formed in advance through pressing and cutting processes while making the crimp terminal 10 from a metal plate.

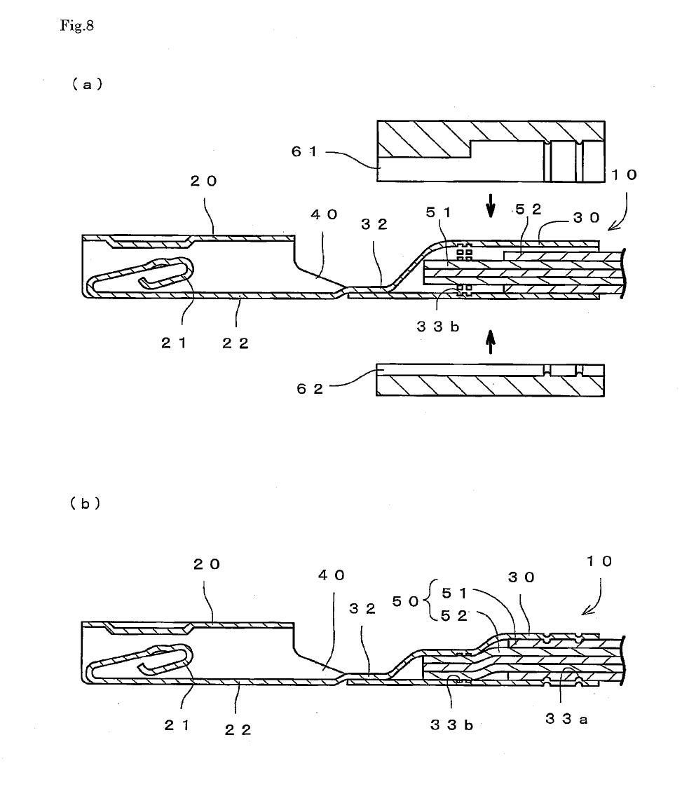

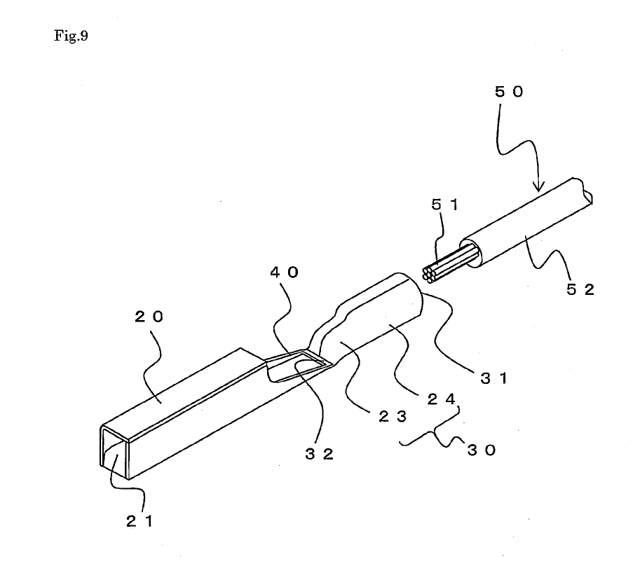

Alternatively, forming the compression part for waterproofing 33a and the like and crimping with a crimping tool may be done at the same time. To be specific, the first crimp mold 61 and the second crimp mold 62 having protrusions (or grooves) formed are used as shown in FIG. 8 (a). Crimping with this crimp tool makes the protrusions of the first crimp mold 61 and the like to press the cable connector 30 forming protrusions on the interior wall 33, which are pressed into the covered part 52. This makes it possible for simultaneous operation of crimping and forming of the compression part for waterproofing 33a and the like. Although only the compression part for waterproofing 33a is formed with this method in FIG. 8, the pressing part for conduction 33b may also be formed using the same method.

As described above, the crimp terminal 10 in this embodiment includes the box part 20 and the cable connector 30. The box part 20 is connected to another terminal. The cable connector 30 is coupled with the box part 20 and connects with the covered cable 50. Also, the cable connector 30 includes a hollow formed by welding a metal plate, and the pressing part for conduction 33b and the compression part for waterproofing 33a are formed inside the hollow. The pressing part for conduction 33b presses the conduction part 51 of the covered cable 50 so as to ensure electrical conduction with the covered cable 50. The compression part for waterproofing 33a presses the covered part 52 of the covered cable 50 inwardly compressing the covered part 52 to prevent entering of water into the cable connector 30.

Thereby, entering of water into the crimp terminal 10 is completely prevented with the welding process and the act of the compression part for waterproofing 33a while the pressing part for conduction 33b ensures the conduction with the covered cable 50. Also, this way of preventing water from entering can reduce cost significantly compared to the structure utilizing molded resin and the like. Furthermore, since the covered part 52 of the covered cable 50 is compressed and fixed, the covered cable 50 can be prevented from coming off even if a force pulling the cable 50 is applied.

In the crimp terminal 10 in this embodiment, the compression part for waterproofing 33a and the pressing part for conduction 33b comprise grooves of protrusions.

Thereby, even if an oxide film is formed on the conduction part 51, the pressing part for conduction 33b and the conduction part 51 can be securely and electrically connected with means of the edges of the grooves or protrusions. Also, making the grooves or the protrusions pressed into the covered part 52 can completely prevent entering of water.

In the crimp terminal 10 in this embodiment, the compression part for waterproofing 33a is formed over the whole circumference of the interior wall of the hollow.

Thereby, the covered part 52 of the covered cable 50 can be compressed over the whole circumference thereof allowing better waterproofing property.

In the crimp terminal 10 in this embodiment, the pressing part for conduction 33b comprises a plurality of polygonal grooves or protrusions.

Thereby, the number of grooves or protrusions can be increased so that the pressing part for conduction 33b can be electrically connected with the conduction part 51 more securely

In the crimp terminal 10 in this embodiment, a welding part (welded part A) formed parallel to the insertion direction of the covered cable 50 exists on the surface of the cable connector 30. The end of the cable connector 30 on the box part 20 side is sealed by welding (welded part B).

Thereby, the cable connector 30 is sealed everywhere except for the cable insertion part, which ensures waterproofing effect. It is also possible to reduce the costs significantly compared to the configuration utilizing molded resin and the like.

As described above, the present invention has two different types of projection-recess structures: one for ensuring connection with the conduction part 51 and another one for compressing the covered part 52. Therefore, both electrical connection at the conduction part 51 and waterproofing at the covered part 52 can be ensured at the same time.

The above mentioned preferred embodiment and its variations of the present invention may be varied as follows.

The shapes and the locations of the compression part for waterproofing 33a and the pressing part for conduction 33b are not limited to those as described above but may be changed accordingly.

The crimp terminal 10 may be used as a terminal to connect single wires (or to connect a single wire with an electrical device). Also, a plurality of the crimp terminals 10 may be arranged as to function as a part of a joint connector.

The method and the location of the welding may be changed accordingly. Also the crimp terminal 10 is not limited to the structure made from a sheet of metal plate. For example, the box part 20 and the cable connector 30 may be separately formed and then coupled later using an appropriate method such as welding.

The shape of the cable connector 30 may be changed accordingly. For example, although one end of the cable connector 30 above is sealed with the sealed part 32, both ends may be opened if the other end coupled to the box part 20 is appropriately waterproofed. Also, the opening 31 of the cable connector 30 may be bent outward so to make the insertion of the cable easier.

Although the crimp terminal 10 is described above as an example of a female connector, the crimp terminal 10 of the present application can also be applied to a male connector.

The cable with a terminal 1 is expected to be applied, for an example, to cable harnesses installed in automobiles but also can be a part of connectors, which is used under conditions in which waterproofing is required.

Also, it may be possible to use a plurality of the cable with a terminal of the present invention bundled together. In the present invention, this structure in which a plurality of cables (cable harnesses) with terminals are bundled together is called a cable harness structure.

### Other Embodiment 2

Also, although the diameter of the cable connector 30 before crimping is uniform in the embodiments described above, the diameter of the part for crimping the conduction part 51 (hereinafter called a wire crimping part 23) may be different from the diameter of the part for crimping the covered part (hereinafter called a covering crimping part 24). For example, the structure can be made as a step form in which the diameter of the covering crimping part 24 is larger than the diameter of the wire crimping part 23. In this case, a pressing part for conduction 33b is provided on the inner side of the wire crimping part 23 and a compression part for waterproofing 33a is provided on the inner side of the covering crimping part 24.

### Other Embodiment 3

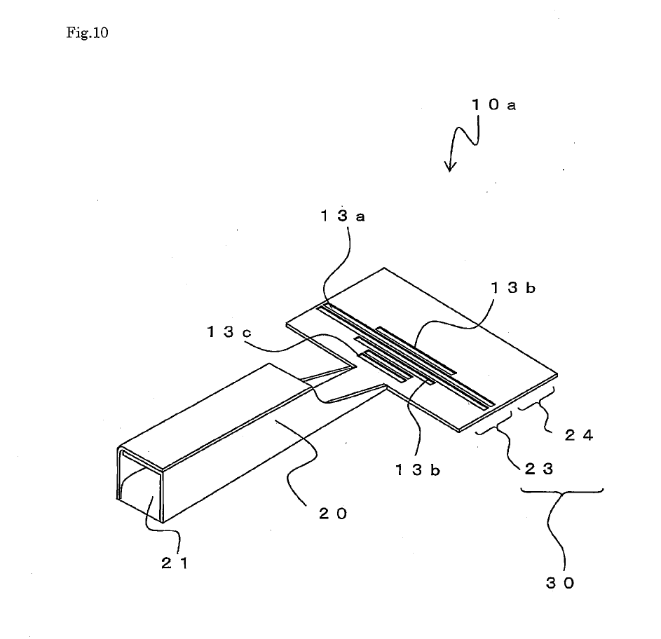

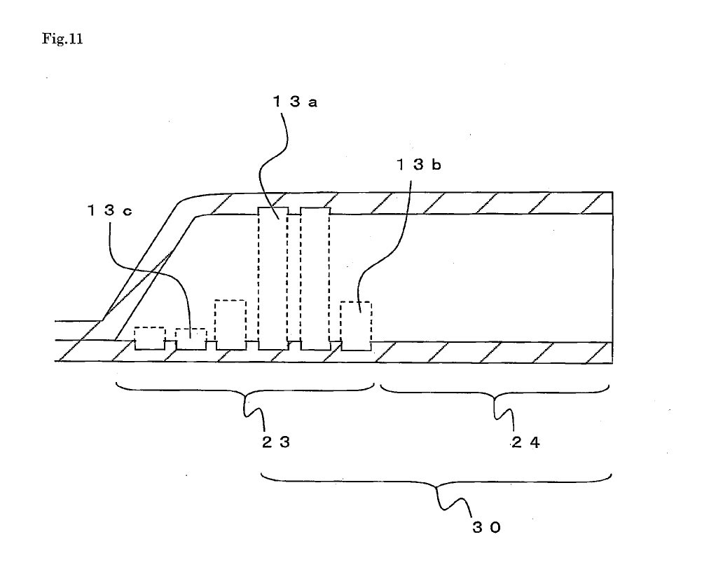

FIG. 10 is a partially developed view of a crimp terminal 10a and FIG. 11 is a partial cross-sectional view of a cable connector 30. As shown in FIG. 10 and FIG. 11, the cable connector 30 is rolled to form a cylinder having a circular section, and its side edges are welded to be unified. A covered cable 50 is inserted into the opening of the cylindrical cable connector 30. The cable connector 30 includes a covering crimping part 24 and a wire crimping part 23.

On the wire crimping part 23, recesses 13a, 13b, and 13c, which act as linear locking parts, are provided at equal spaces in the axial direction of the cable connector 30. The recesses 13a, 13b and 13c correspond to the pressing part for conduction 33b and are continuous grooves on the inner surface of the cable connector 30.

As shown in FIG. 10, the recesses 13a as main recesses are formed over approximately whole width of the cable connector 30 (the circumference of the cable connector 30 after it is made into a cylinder). Both edges in the width direction are to be welded so the recesses 13a are stopped slightly before the edges. The recesses 13b as sub-recesses are shorter than the recesses 13a. For example, the length of the recesses 13 b are as half as that of the recesses 13a. Therefore, when the cable connector 30 is made into a cylinder, the recesses 13b are formed only at the semi-circular part of the approximately lower part of the cylinder. The recesses 13c are further shorter in length than the recesses 13b. The recesses 13c are, for example, formed in the size which is approximately equal to the width of the bottom surface of the box part 20.

As shown in FIG. 11, the recesses 13a are formed approximately at the center vicinity of the wire crimping part 23 in the axial direction of the cable connector 30 (the right-left direction in FIG. 11 and the insertion direction of the covered cable 50). The recesses 13b are formed on both sides (front and back) of the recesses 13a in the axial direction of the cable connector 30. The recesses 13c are formed in front of the recesses 13b (on the side of the box part 20). The number of recesses 13a, 13b, and 13c are not limited to those shown in the drawings and may be set accordingly.

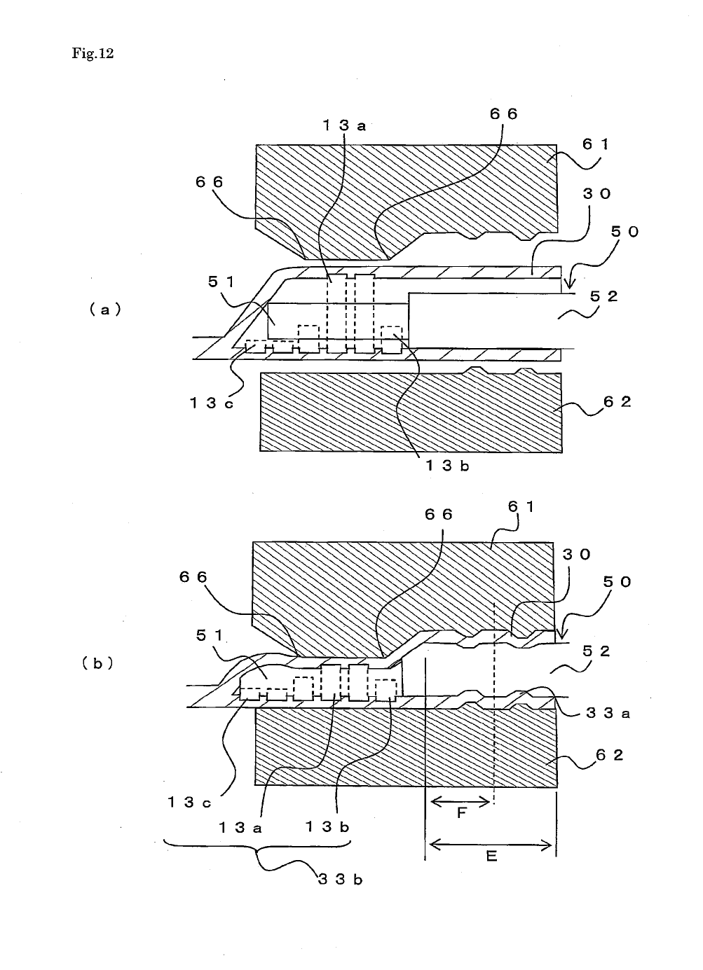

FIG. 12 shows a process of forming a cable harness, in which the covered cable 50 is inserted into the cylindrical cable connector 30. As mentioned above, the cable connector 30 is rolled into an approximately cylindrical shape, and the edges thereof are then welded. The cable connector 30 is sealed everywhere except for the insertion part of the covered cable 50.

The covered cable 50 includes a conduction part 51 covered by the covered part 52. When inserting the covered cable 50 into the cable connector 30, a part of the covered part 52 at the tip of the covered wire 50 is removed to expose the conduction part 51.

Thereby, the covering crimping part 24 is in contact with the covered part 52 and seals the cable connector 30 after crimping. The cable connector 30 is now sealed water-tight except for the rear edge so that entering of water into the cable connector 30 can be prevented.

First, as shown in FIG. 12(a), the tip of the covered cable 50 is inserted into the cable connector 30. FIG. 12(a) is a side cross-sectional view of the cable connector 30 with a first crimping mold 61 and a second crimping mold 62 which are to crimp the cable connector 30.

The first crimping mold 61 has a straight part formed at the part corresponding to the wire crimping part 23 to the axial direction of the cable connector 30. The section of the straight part is approximately straight. Tapered parts are formed on both sides of the straight part so that the first crimping mold 61 has an inverted trapezoid projection at the approximately center part in the crimping direction. Therefore, the compressibility is high at the straight part which is a strong crimping part. At the boundary between the straight part and the tapered part, mold corners 66 are formed. The recesses 13a are provided at the parts corresponding to the straight part of the first crimping mold 61 and the recesses 13b are provided at the parts corresponding to the mold corners 66.

Protrusions are formed on the first and second crimping molds 61 and 62 over the circumference of the part corresponding to the covering crimping part 24. Two protrusions, for example, can be disposed. The protrusions form the compression part 33a after crimping.

FIG. 12(b) is a cross-sectional view of the first and the second crimping molds 61 and 62 in crimping. The cable connector 30 is put between the first and the second crimping molds 61 and 62 and the wire crimping part 23 and the conduction part 51 are crimped.

The conduction part 51 flows as being pushed by the recesses 13a, 13b, and 13c. Pushing the conduction part 51 by the recesses 13a, 13b, and 13c ensures stronger crimping force. Also, flowing of the surface of the conduction part 51 breaks the oxide film on the surface and reduces the electrical resistance between the conduction part 51 and the wire crimping part 23. This is particularly in full effect if the conduction part 51 is made of aluminum materials.

The recesses 13a are formed over approximately whole circumference of the wire crimping part 23 at the part that is to be crimped by the straight part of the first crimping mold 61. Therefore, the conduction part 51 flows into the recesses 13a so that the conduction part 51 can be held by approximately whole circumference of the wire crimping part 23.

On the other hand, recesses 13b are formed at the part which is to be crimped by the mold corners 66. Stress force concentrates on the mold corners 66 in crimping and a crack may occur at the part corresponding to the mold corner 66 when crimped by the first crimp mold 61. Therefore, compressing the part having the recesses 13b by the mold corners 66 may cause a crack at the thinner part that is made due to the recesses 13b. In the present invention, the recesses 13b are formed only at the approximately lower semi-circumference of the wire crimping part 23 and are not formed on the upper part. Therefore, no thin part is formed at the part corresponding to the mold corners 66, and cracks can be prevented.

When the conduction part 51 is crimped, the conduction part 51 extends in the axial direction and therefore flows to the front edge side of the cable connector 30. The tip of the flowed conduction part 51 is then pushed into the recesses 13c holding the conduction part 51. In the present invention, it is required that the recesses 13b at the part corresponding to the mold corner 66 are shorter than the others and are not formed on the upper part of the wire crimping part 23. Therefore, the recesses 13c are not always necessary, or may be formed over approximately whole circumference of the cable connector 30. As described above, the recesses 13a, 13b, and 13c act as the pressing part for conduction 33b.

Also, at the covering crimping part 24, the protrusions of the first and the second crimping mold 61 and 62 form protrusions on the inner side of the cable connector 30 (compression part for waterproofing 33a). That is, the parts pressed by the protrusions of the molds 61 and 62 stronger than the other parts can compress the covered part 52 harder to ensure waterproofing property.

Here, ‘E’ in the drawing is the longitudinal length of the covering crimping part 24 and ‘F’ is the distance from the front edge to the center of the covering crimping part 24. The protrusions of the compression part for waterproofing 33a is preferably disposed in front of the bisection line of the longitudinal length of the covering crimping part 24 (on the side of the wire crimping part 23). If more than two protrusions are provided, the one closest to the front edge is required to be disposed in front of the bisection line. This is based on the following reasons.

With the use of the first and second crimping mold 61 and 62, the diameter of the crimp terminal 10a tends to widen slightly toward the rear edge (to the right in the drawing). That is, the covered part 52 of the covered cable 50 extending from the rear edge is not pressed by the crimp terminal 10a and has a larger diameter than that of the pressed part. The covered part 52 has elasticity and a tendency to incline making the diameter thereof larger toward the rear edge. Thereby, corresponding to the inclination of the covered cable 50, the crimp terminal 10a (the covering crimping part 24) inclines widening the diameter thereof larger toward the rear edge.

It is difficult to obtain desired crimping force if the protrusions are formed on the part in which the diameter widens as described above. However, disposing the protrusions in front of the center of the covering crimping part 24 allows the protrusions not to be greatly influenced by the widening of the diameter. That is, the covered part 52 can be securely crimped by the protrusions.

As described above, in this embodiment, the conduction part 51 can be securely held as the conduction part 51 is pressed into the recesses 13a, 13b, and 13c, which form pressing part for conduction 33b. Also, the recesses 13b are provided on the wire crimping part 23 at the part corresponding to the mold corner 66. The recesses 13b are formed on the lower half of the cable connector 30 without extending to the upper surface. Therefore, the thinner part is not formed when pressed by the mold corners 66, therefore preventing cracks in the cable connector 30.

Also, in this embodiment, the compression part for waterproofing 33a is formed when crimped with the first and second crimping molds 61 and 62. Therefore, insertion of the covered cable 50 into the cable connector 30 is not obstructed by the protrusions.

In this embodiment, an example having two protruded lines is shown. This is because higher tensile force and waterproofing property can be obtained with two or more protrusions formed as mentioned above.

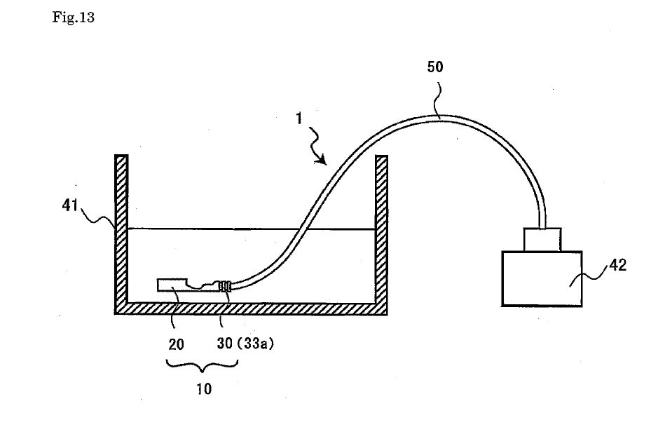

Water cut-off performance depending on the number of the protrusions is evaluated in practice. In the cable with a terminal 1, air is sent from the covered part 52 of the covered cable 50 toward the crimp terminal 10 to test whether the air leaks out of the rear end of the terminal or not. The method of the experiment is outlined in FIG. 13. In the experiment, the crimp terminal 10 to which the covered cable 50 is crimped is placed into water in a water tank 41 and then pressurized air is sent from the end part of the covered cable 50 toward the crimp terminal 10 by a regulator 42. The pressure of the air is increased up to 200 kpa.

TABLE 1

| | number of | | |
|---|---|---|---|
| | protruded | ‘n’ | |
| | lines | number | |
| Sample 1 | 0 | 1 | 90 kPa |
| | | 2 | 200 kPa |
| | | 3 | 200 kPa |
| | | 4 | 200 kPa |
| | | 5 | 200 kPa |
| Sample 2 | 1 | 1 | 200 kPa |
| | | 2 | 200 kPa |
| | | 3 | 200 kPa |
| | | 4 | 140 kPa |
| | | 5 | 200 kPa |
| Sample 3 | 2 | 1 | 200 kPa |
| | | 2 | 200 kPa |
| | | 3 | 200 kPa |
| | | 4 | 200 kPa |
| | | 5 | 200 kPa |

No protrusion for the compression part for waterproofing 33a is provided in Sample 1. Sample 2 has one protruded line and Sample 3 has two protruded lines, which are formed around the circumference of the compression part for waterproofing 33a. “200 kPa” in Table 1 means that air-leak is not detected at the pressure of up to 200 kPa.

According to the results, with the Sample 1 having no protrusion, an air-leak was detected at 90 kPa in one of the experiments of n=5. That is, the minimum leaking pressure is 90 kPa. With Sample 2, an air-leak was detected at 140 kPa in one of the experiments of n=5, which is a better result than the experiments with Sample 1. No air-leak was detected at 200 kPa in all the experiments of n=5 with Sample 2 having two lines of protrusions. Therefore, it is concluded that providing a protrusion improves water cut-off performance and even a better result can be obtained by forming two lines of protrusions.

### Other Embodiment 4

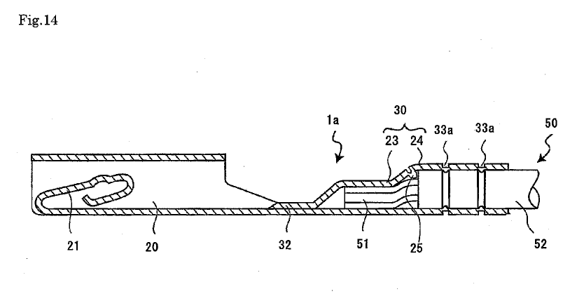

FIG. 14 is a cross-sectional view of a cable with a terminal 1a. The pressing part for conduction 33b is omitted in the drawings in this embodiment. The covered cable 50 is inserted into the cable connector 30. As described above, the conduction part 51 is located at the wire crimping part 23 and the covered part 52 is located at the covering crimping part 24.

The cable connector 30 is caulked by the molds mentioned above with the covered cable 50 inserted thereto. Thereby, the wire crimping part 23 and the conduction part 51 are crimped, and the covering crimping part 24 and the covered part 52 are crimped.

The protrusions for compression part for waterproofing 33a are provided at the covering crimping part 24. Also, since the wire crimping part 23 is compressed and crimped more strongly than the covering crimping part 24, a tapered part, having a gradually changing amount of compression, is formed between the wire crimping part 23 and the covering crimping part 24. That is, the tapered part is formed in a vicinity of the boundary of the conduction part 51 and the covered part 52. This type of tapered part is formed, for example, with a tapered shape of the first crimping mold 61.

A projection 25 that protrudes inwardly is provided on the tapered part. The projection 25 can be located anywhere on the tapered part. That is, the projection 25 is provided at any place that corresponds to the tapered part when crimped. Although the example above shows the tapered part formed only on the upper part, the tapered part may be formed over the whole circumference. Also, the projection 25 may be formed with the mold when crimping, or may be formed in advance as a terminal.

Here, the outer diameter of the conduction part 51 is different from that of the covered part 52 before crimping. Thus, level difference is formed between the conduction part 51 and the covered part 52 with different diameters. The projection 25 is preferably provided at the part corresponding to the level difference of the diameters formed between the conduction part 51 and the covered part 52.

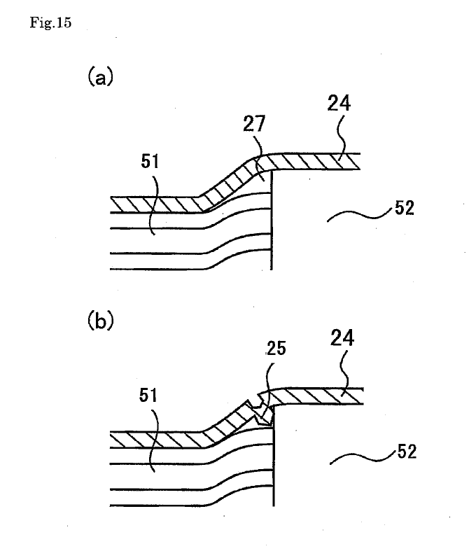

FIG. 15 is an enlarged view of a vicinity of the tapered part formed between the conduction part 51 and the covered part 52. As shown in FIG. 15 (a), if there is no shape such as the projection 25 in the vicinity of the tapered part, an air pocket 27 according to the tapered shape is formed. This is because the conduction part 51 and the covered part 52 inside cannot exactly follow the change in the shape of the tapered part which is formed at the boundary of the wire crimping part 23 and the covering crimping part 24. The tapered part is formed because the amount of compression on the wire crimping part 23 is different from the amount of compression on the covering crimping part 24.

Such an air pocket may cause thermal expansion of the air in practical use. In that case, the air escapes from the gap between the covered part 52 and the covering crimping part 24 to the outside and water may enter along the path of the air-flow. Therefore, it is preferable to make such air pockets as small as possible.

On the other hand, as shown in FIG. 15 (b), providing the projection 25 at the tapered part allows the air pocket 27, which is formed by the tapered part and the level difference of the diameters, to be small. That is, the projection 25 protrudes to the air pocket 27 making this space smaller. Therefore, air-leak or accompanying entering of water can be prevented.

### Other Embodiment 5

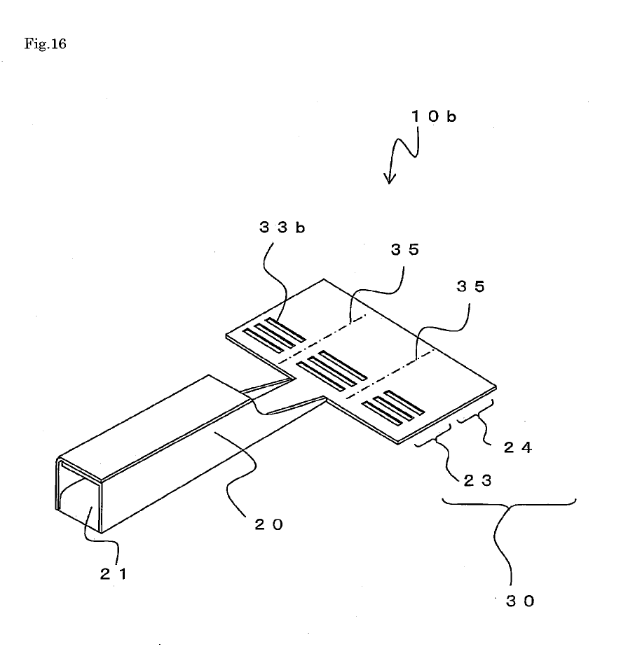

FIG. 16 is a developed view of a cable connector 30 of a crimp terminal 10b. The compression part for waterproofing 33a is omitted in the drawings of this embodiment. Inside the cable connector 30, a plurality of grooves for the pressing part for conduction 33b is provided in the width direction at equal spaces. The spaces between the grooves for the pressing part for conduction 33b provided in the width direction at equal spaces are flat without unevenness. Here, imaginary lines 35 stretching in the longitudinal direction between the grooves for the pressing part for conduction 33b provided in the width direction at equal spaces are assumed. That is, grooves for the pressing part for conduction 33b are not formed on the imaginary lines 35.

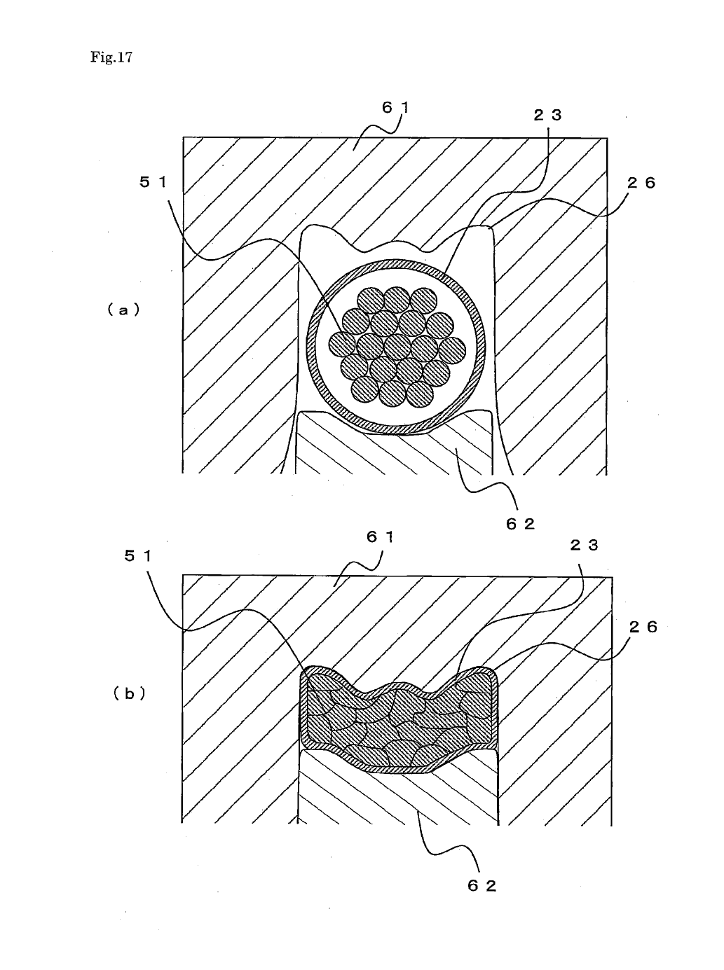

FIG. 17 (a) and FIG. 17 (b) illustrate a process of crimping the wire crimping part 23 with molds. FIG. 17 (a) is a side cross-section before crimping and FIG. 17 (b) is a side cross-section after crimping. The mold for crimping the wire crimping part 23 includes the first and second crimping molds 61 and 62. The first crimping mold 61 has a projection protruding downwardly at approximately upper center and shoulder parts 26 on both sides of the projection in the width direction thereof.

The second crimping mold 62 has a recess that can engage with the first crimping mold 61. The wire crimping part 23 with the conduction part 51 inserted is disposed between the first and second crimping molds 61 and 62 that are facing each other. The first and second crimping molds 61 and 62 are pressed together allowing the conduction part 51 and wire crimping part 23 to be crimped.

In this embodiment, the imaginary lines 35 mentioned above are located at the parts that correspond to the shoulder parts 26. That is, the vicinity of the imaginary lines 35 is flat and the grooves for the pressing part for conduction 33b are not provided thereon. Therefore, no grooves for the pressing part for conduction 33b are formed on the vicinity of parts that are to be compressed by the shoulder parts 26.

In the wire crimping part 23, the vicinity of the shoulder parts 26 on both sides deforms greatly and the shoulder parts 26 tend to become thinner than the other parts. Forming the grooves for the pressing part for conduction 33b on the thin parts may cause cracks. However, with the flat parts having no grooves for the pressing part for conduction 33b at the parts corresponding to the shoulder parts 26, cracks can be prevented even if the shoulder parts 26 become thin.

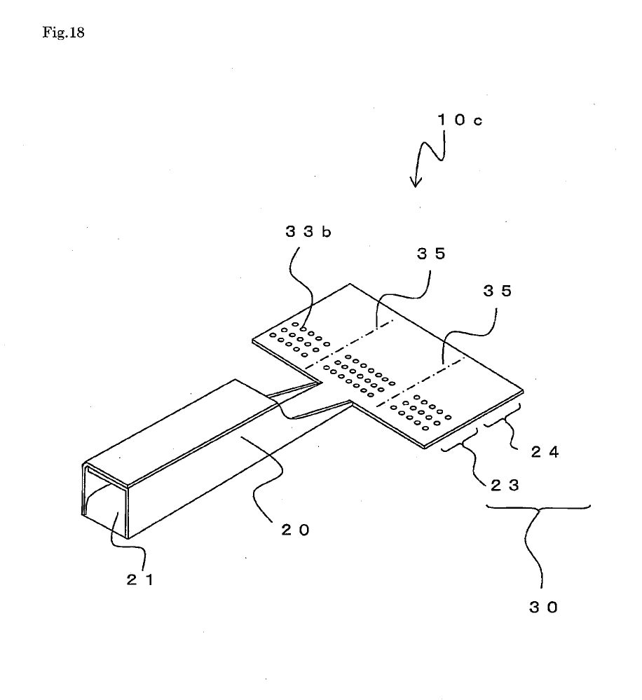

Although the grooves for the pressing part for conduction 33b are in the shapes of straight stretching lines in this embodiment, the shapes may have curves as well. For example, FIG. 18 shows a crimp terminal 10c having another aspect of the grooves for the pressing part for conduction 33b. As shown in the drawing, the grooves for the pressing part for conduction 33b may be a large number of dot shaped grooves arranged at intervals in the width direction as if linear grooves are formed as a whole. And, although the plane shape of the groove is approximately circular above, the shapes can be rectangle or parallelogram.

Though a drawing is omitted, the grooves for the pressing part for conduction 33b may not also be formed on the lower part of the wire crimping part 23 (for example, the vicinity of the lower center part that is in contact with the second crimping mold 62 in FIG. 17 (b)). That is, this part may be a flat part.

Furthermore, this part may have a projection protruding inwardly. The projection is formed continuously in the longitudinal direction of the wire crimping part 23.

By using a terminal with the projected line that is formed in the vicinity of the center of the lower side of the wire crimping part 23 and is protruding toward the inner circumference, the conduction part 51 can be securely crimped due to the following reasons. That is, when the conduction part 51 is crimped, the wire crimping part 23 is deformed into a U-shape with a protruding lower surface. The vicinity of the projection is compressed greatly, ensuring the mobility of the conduction part 51. Therefore, the conduction part 51 can flow from the center to the sides of the wire crimping part 23.

### Other Embodiment 6

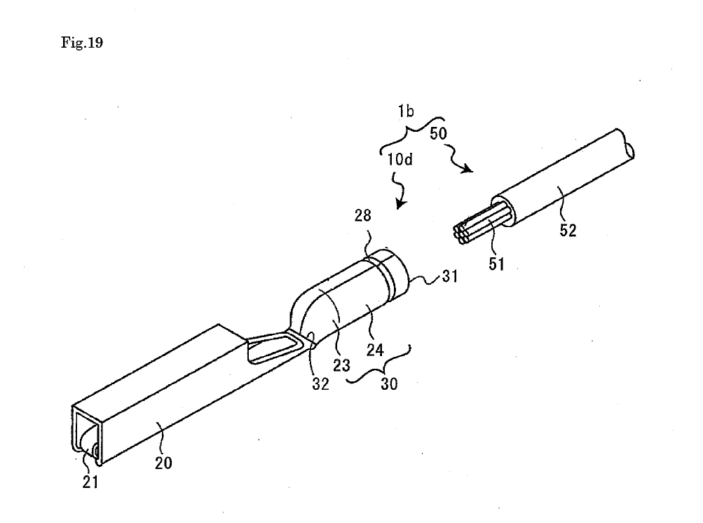

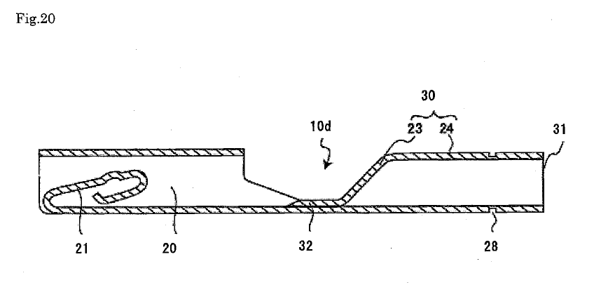

FIG. 19 is an exploded perspective view of a cable with a terminal 1b before caulking. FIG. 20 is a longitudinal cross-sectional view of a crimp terminal 10d. The cable with a terminal 1b has a covered cable 50 and the crimp terminal 10d. In this embodiment, drawings for the pressing part for conduction 33b are omitted.

In the cable connector 30 of the crimp terminal 10d, a recess 28 is formed on the outer surface of the covering crimping part 24. The recess 38 is annularly formed around the circumference of the covering crimping part 24. The inner surface side of the covering crimping part 24 that corresponds to the recess 28 does not have unevenness and is flat as shown in FIG. 20. This allows to seal the rear end of the covering crimping part 24 (the cable insertion side) water-tight by contacting the covering crimping part 24 and the covered part 52 after crimping.

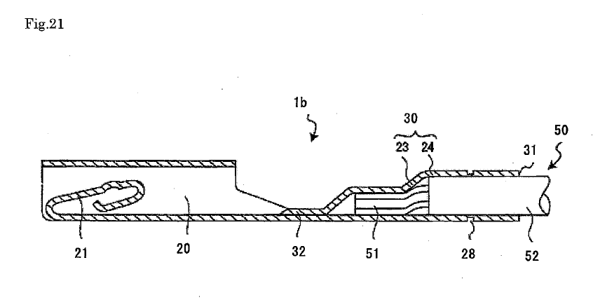

FIG. 21 is a cross-sectional view of the cable with a terminal 1b showing the wire crimping part 23 and covering crimping part 24 which are caulked in a radial direction inwardly and crimped. The covered cable 50 is inserted into the cable connector 30. The cable connector 30 is caulked in this state. Thereby, the wire crimping part 23 is crimped with the conduction part 51, and the covering crimping part 24 is crimped with the covered part 52.

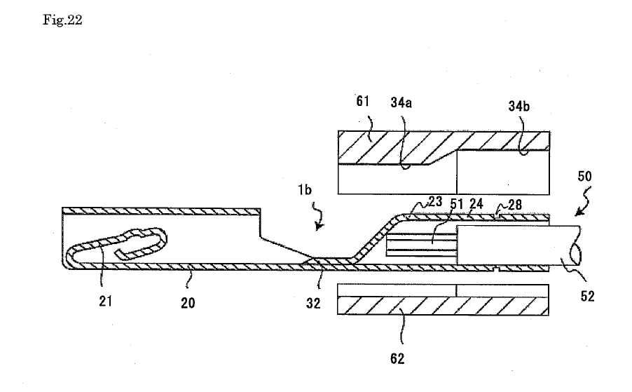

The method for crimping the cable with a terminal 1b will be described next. FIG. 22 is a schematic view showing the crimping method of the cable with a terminal 1b. As shown in the drawing, the wire crimping part 23 and the covering crimping part 24 can be crimped with a crimping tool. The crimping tool includes a first and a second crimping mold 61 and 62. The inner shape of the first crimping mold 61 is approximately semi-circular. The first crimping mold 61 has a large diameter part 34b and a small diameter part 34a, which has a smaller diameter than the large diameter part 34b. The large diameter part 34b corresponds to the covering crimping part 24. The small diameter part 34a corresponds to the wire crimping part 23. That is, the wire crimping part 23 is compressed and crimped more greatly than the covering crimping part 24.

Both of the small diameter part 34a and the large diameter part 34b have diameters smaller than that of the cable connector 30 before crimping. The inner shape of the second crimping mold 62 is approximately semi-circular and the diameters are the same for both of the parts that correspond to the wire crimping part 23 and the covering crimping part 24. By using the first and the second crimping molds 61 and 62 together, the object for the compression can be compressed into an approximately circular shape in cross section. The shape of the compressed part is not limited to the one in the drawing but may be other shapes.

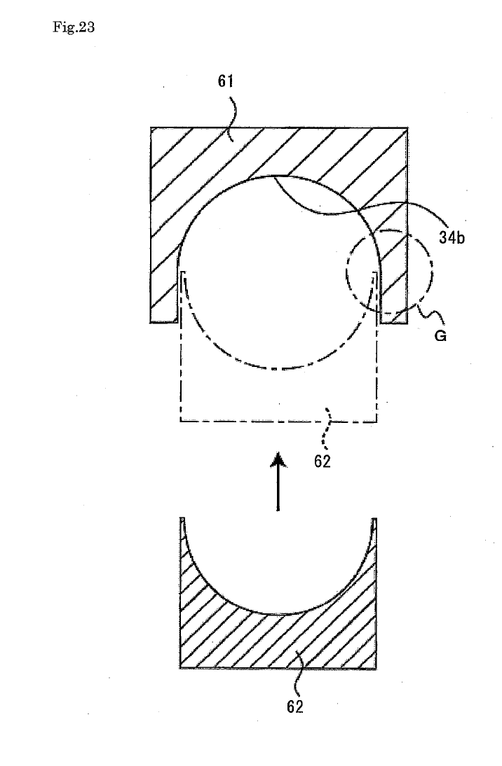

FIG. 23 is a cross-sectional view of the crimping tool. As shown in the drawing, a slight difference in level can be created between the inner surface of the first crimping mold 61 and the outer surface of the second crimping mold 62 at the fitting section thereof.

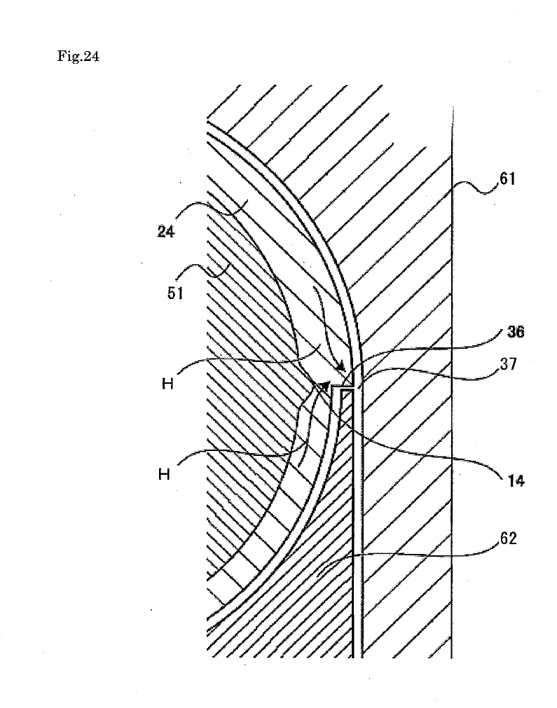

FIG. 24 is an enlarged view of the vicinity of the fitting section of the upper and lower molds (G part in FIG. 23) when the terminal is crimped. When the terminal and the cable are crimped, the pressure force of the covering crimping part 24 moves to escape toward the level difference at the fitting section 37 forming a protrusion 36 on the covering crimping part 24. Thus, when the protrusion 36 is formed, the conductor of the covering crimping part 24 flows toward the protrusion (in the direction of an arrow H in the drawing). This flow of the conductor forms a depression 14 on the inner surface of the covering crimping part 24. The depression 14 formed decreases the amount of compression at the covering part 52 at the corresponding part and may cause entering of water between the covering crimping part 24 and the covered part 52.

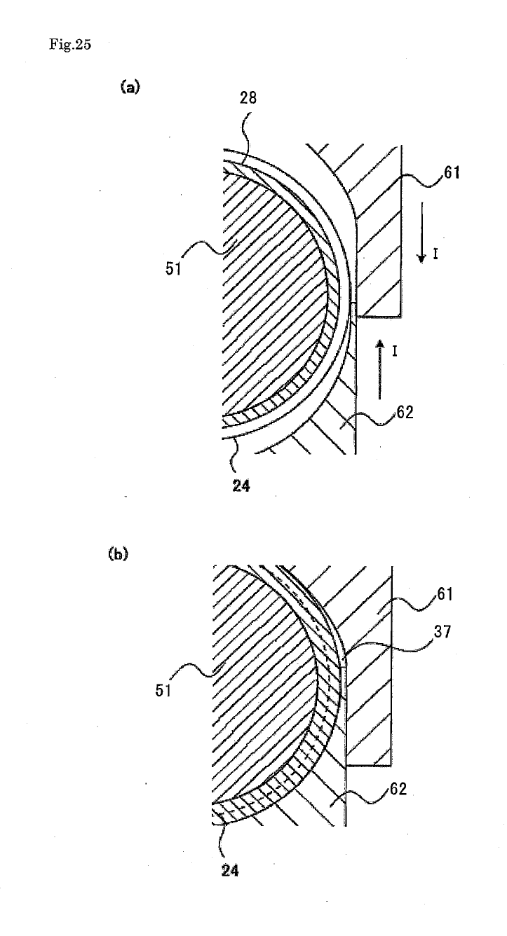

FIG. 25 is an enlarged view of the recess 28 in the vicinity of the fitting section in this embodiment. As shown in FIG. 25 (a), since the recess 28 is formed ring-shaped in the present invention, the recess 28 always exists at the fitting section of the molds before crimping. When crimping is performed in this state, as shown in FIG. 25 (b), the conductor around the recess 28 flows toward the recess 28. That is, the covering crimping part 24 flows toward the direction vertical to the plane of the paper in FIG. 25 (b). This can prevent the conductor from flowing outwardly. The cross-sectional area of the recess 28 is preferably equivalent to the volume of the protrusion 36 above.

Thus, in this embodiment, since the covering crimping part 24 is prevented from flowing outwardly and forming protrusions, depressions are not formed on the inner surface of the covering crimping part 24. Therefore, the covered part 52 can be compressed uniformly by the whole inner surface of the covering crimping part 24. As a result, watertight sealing between the covering crimping part 24 and the covered part 52 at the vicinity of the fitting section 37 of the upper and lower molds is not impaired.

Thus, according to this embodiment, the covering crimping part 24 is prevented from flowing outwardly at the vicinity of the fitting section 37 of the upper and lower molds and forming the protrusions, allowing the inner surface thereof to be kept smooth. As a result, the watertight property between the covering crimping part 24 and the covered part 52 can be ensured.

Particularly, providing the recess 28 in the circumference direction makes the covering crimping part 24 easier to escape in longitudinal direction. Therefore, the extension of the terminal can be prevented. Thus, in this embodiment, the waterproofing property can be enhanced with the recess 28 formed on the outer surface without unevenness formed on the inner surface. That is, the recess 28 functions as the compression part for waterproofing 33a.

### Other Embodiment 7

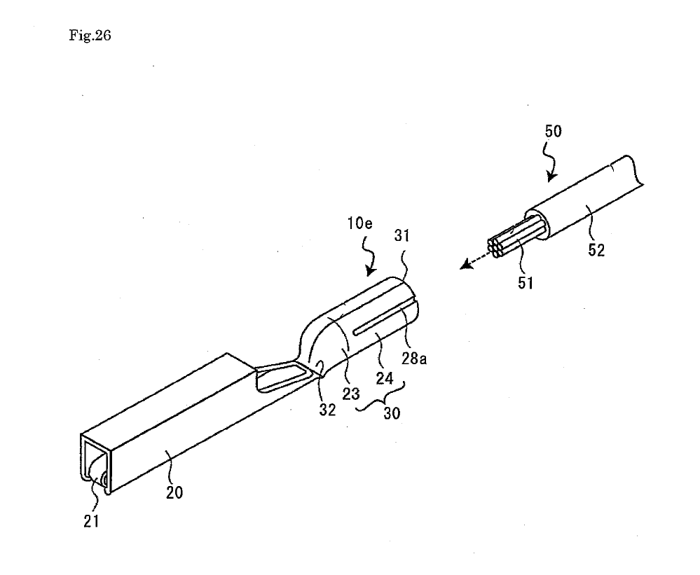

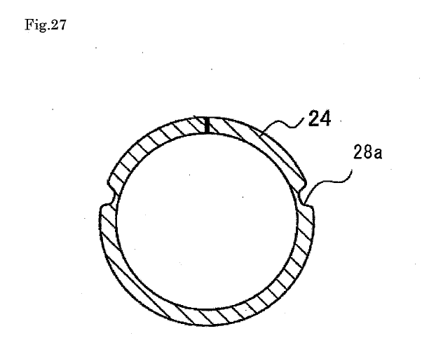

FIG. 26 is an exploded perspective view of a cable with a terminal according to another embodiment of the present invention. FIG. 27 is a cross-sectional view of the covering crimping part 24. In this embodiment, a recess 28a, instead of the recess 28, is formed on the circumference surface of a crimp terminal 10e.

The recess 28a is formed along the longitudinal direction of the outer circumference surface of the covering crimping part 24. Therefore, as shown in FIG. 27, the recess 28a is formed only on some parts (two parts of the circumference) in the cross section of the covering crimping part 24. Unevenness is not formed on the inner side of the recess 28a (the inner surface of the covering crimping part 24).

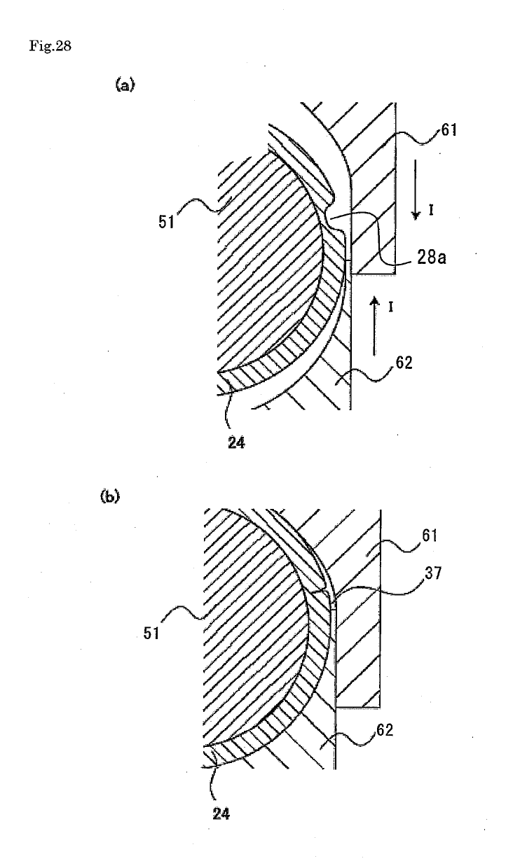

FIG. 28 show the crimping of such terminal. First, the covering crimping part 24 is set in the mold as shown in FIG. 28 (a), and the terminal is then crimped as shown in FIG. 28 (b). Here, the recesses 28a are disposed at the parts corresponding to the fitting section of the first and the second crimping molds 61 and 62. When crimping is performed in this state, the covering crimping part 24 flows (deforms) as to crush the recess 28a. That is, the covering crimping part 24 flows (deforms) toward the direction in which the recess 28a is filled up. Therefore, the covering crimping part 24 can be prevented from flowing outwardly. The cross-sectional area of the recess 28a is preferably equivalent to the volume of the protrusion 36 above.

In the case in which the recess 28a is provided in the longitudinal direction, it is preferable that the recess 28a is formed slightly above the fitting section 37 (the curved part of the first crimping mold 61).

Thus, in this embodiment, since the covering crimping part 24 is prevented from flowing outwardly and forming protrusions, depressions are not formed on the inner surface of the covering crimping part 24. Therefore, the covered part 52 can be compressed uniformly by the whole inner surface of the covering crimping part 24. As a result, watertight sealing between the covering crimping part 24 and the covered part 52 at the vicinity of the fitting section 37 of the upper and lower molds is not impaired. That is, the recess 28a functions as the compression part for waterproofing 33a.

### Other Embodiment 8

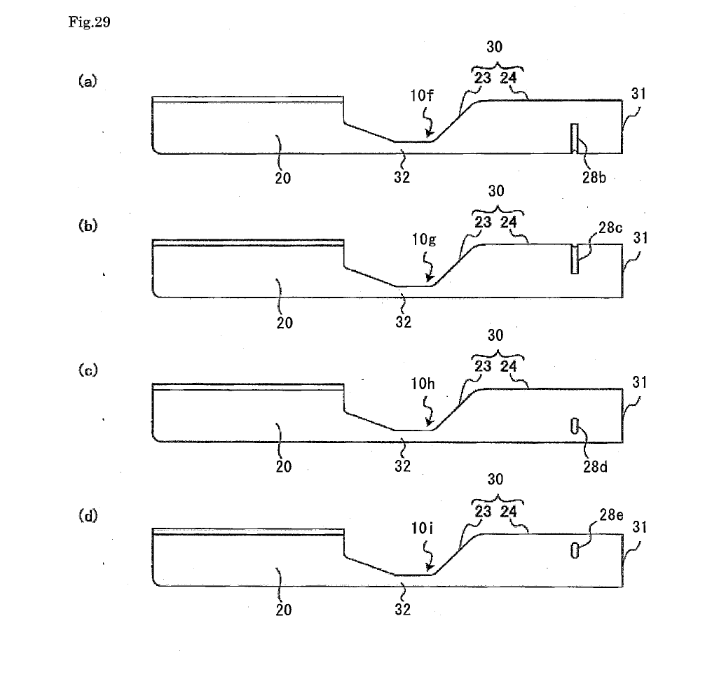

If the fitting section is on the lower side of the covering crimping part 24, a recess 28b may be formed only on the lower side of the covering crimping part 24 as in a crimp terminal 10f shown in FIG. 29 (a). Similarly, if the fitting section is on the upper side of the covering crimping part 24, a recess 28c may be formed only on the upper side of the covering crimping part 24 as in a crimp terminal 10g shown in FIG. 29 (b). Or, if the fitting section is on the lower side of the covering crimping part 24, a recess 28d may be formed only on a part of the lower side of the covering crimping part 24 as in a crimp terminal 10h shown in FIG. 29 (c). Or, if the fitting section is on the upper side of the covering crimping part 24, a recess 28e may be formed only on a part of the upper side of the covering crimping part 24 as in a crimp terminal 10i shown in FIG. 29 (d). It is not necessary to form unevenness on the inner surface of the recesses 28b, 28c, 28d, and 28e.

Although the recesses 28, 28a, 28b, 28c, 28d, and 28e are placed only at one part in the longitudinal direction in the above examples, the recesses may be formed and arranged on a plurality of locations (in double rings if ring-shaped) in the longitudinal direction.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, descriptions mentioned above for each of the embodiments may be applied to other embodiments as long as there is no contradiction. Also, each composition in each embodiment is mutually combinable.

### EXPLANATION OF NUMERALS

1, 1a, 1b . . . cables with terminals
10, 10a, 10b, 10c, 10d, 10e, 10f, 10g, 10h, 10i . . . crimp terminals
13a, 13b, 13c . . . recesses
14 . . . depression
20 . . . box part (terminal connector)
21 . . . elastic contactor
22 . . . bottom surface
23 . . . wire crimping part
24 . . . covering crimping part
25 . . . projection
26 . . . shoulder part
27 . . . air pocket
28, 28a, 28b, 28c, 28d, 28e . . . recesses
30 . . . cable connector
31 . . . opening
32 . . . sealed part
33 . . . interior wall
33a . . . compression part for waterproofing
33b . . . pressing part for conduction
34a . . . small diameter part
34b . . . large diameter part
35 . . . imaginary lines
36 . . . protrusion
37 . . . fitting section
40 . . . transition part
41 . . . water tank
42 . . . regulator
50 . . . covered cable
51 . . . conduction part
52 . . . covered part
61 . . . first crimping mold
62 . . . second crimping mold
66 . . . mold corner

1-14. (canceled)

15. A crimp terminal comprising:
a terminal connector being connected to another terminal; and
a cable connector being coupled with the terminal connector and connected with a covered cable, wherein
the cable connector comprises
a cylindrical part including a hollow formed by a plate-like material; and
a sealed part which is formed by deforming one end of the cylindrical part to seal the end, the hollow including
a wire crimping part which crimps a conduction part of the covered cable; and
a covering crimping part which crimps a covered part of the covered cable, wherein
a pressing part for conduction is formed inside the wire crimping part, the pressing part for conduction being capable of ensuring the conduction with the covered cable by pressing the conduction part of the covered cable;
a compression part for waterproofing is formed inside the covering crimping part, the compression part for waterproofing being capable of preventing entering of water into the cable connector by pressing and compressing the covered part of the covered cable;
the pressing part for conduction includes grooves formed on the inner surface of the hollow;
the compression part for waterproofing includes protrusions formed over the whole circumference of the inner surface of the hollow; and
the length of the pressing part for conduction is greater than the length of the compression part for waterproofing in the longitudinal direction of the cable connector.

16. The crimp terminal according to claim 15, wherein:
the compression part for waterproofing comprises a plurality of the protrusions formed on the inner surface of the hollow.

17. A cable with terminals comprising:
a crimp terminal; and
a covered cable being connected to the crimp terminal,
the crimp terminal comprising:
a terminal connector being connected to another terminal; and
a cable connector being coupled with the terminal connector and connected with a covered cable, wherein
the cable connector comprises
a cylindrical part including a hollow formed by a plate-like material; and
a sealed part which is formed by deforming one end of the cylindrical part to seal the end,
the hollow comprising:
the hollow has a wire crimping part which crimps the conduction part of the covered cable; and
a covering crimping part which crimps the covered part of the covered cable, wherein
a pressing part for conduction which ensures the conduction with the covered cable by pressing the conduction part of the covered cable and
the a pressing part for conduction is formed inside the wire crimping part, the pressing part for conduction being capable of ensuring the conduction with the covered cable by pressing the conduction part of the covered cable;
a compression part for waterproofing is formed inside the covering crimping part, the compression part for waterproofing being capable of preventing entering of water into the cable connector by pressing and compressing the covered part of the covered cable;
the pressing part for conduction includes grooves formed on the inner surface of the hollow;
the compression part for waterproofing includes protrusions formed over the whole circumference of the inner surface of the hollow;
the covered cable is connected to the cable connector of the crimp terminal; and
the length of the pressing part for conduction is greater than the length of the compression part for waterproofing in the longitudinal direction of the cable connector.

18. The cable with terminals according to claim 17 wherein:
the amount of compression for the wire crimping part is greater than the amount of compression for the covering crimping part.

19. The cable with terminals according to claim 17 wherein:
protrusions for the compression part for waterproofing are formed at the same time when the covered cable is crimped.

20. The cable with terminals according to claim 17 wherein:
the compression part for waterproofing comprises a plurality of protrusions formed on the inner surface of the hollow.

21. The cable with terminals according to claim 17 wherein:
the crimp terminal has different shapes for the pressing part for conduction and the compression part for waterproofing.

22. The cable with terminals according to claim 17 wherein:
the pressing part for conduction comprises a plurality of polygonal-shaped grooves.

23. The cable with terminals according to claim 17 being installed on automobiles.

24. A wire harness structure comprising a plurality of cables with terminals that are bundled together, the cable with terminals comprising:
the crimp terminal according to claim 15; and
a covered cable being connected to the cable connector of the crimp terminal.

25. A wire harness structure comprising a plurality of cables with terminals according to claim 17, wherein the cables with terminals are bundled together.

26. The wire harness structure according to claim 24 wherein:
a conduction part of the covered cable is made of aluminum or aluminum alloy.

27. The wire harness structure according to claim 25 wherein:
a conduction part of the covered cable is made of aluminum or aluminum alloy.
